(19) United States
(12) Patent Application Publication
(10) Pub. No.: US 2021/0270691 A1
(43) Pub. Date: Sep. 2, 2021

(54) WATERPROOFING MEMBRANE WITH LEAK DETECTION SYSTEM AND METHOD THEREOF

(71) Applicant: Shrikant SHAH, Surat (IN)

(72) Inventor: Shrikant SHAH, Surat (IN)

(21) Appl. No.: 17/255,404

(22) PCT Filed: Nov. 28, 2018
(86) PCT No.: PCT/IN2018/050794

§ 371 Date: Dec. 22, 2020

(30) Foreign Application Priority Data
Jun. 22, 2018 (IN) 201821023368

(51) Int. Cl. G01M 3/40; E04D 5/10; B32B 5/02; B32B 37/18

(52) U.S. Cl. CPC G01M 3/40; B32B 2457/00; B32B 5/024; B32B 5/028; B32B 37/18; B32B 2307/202; B32B 2307/206; B32B 2307/7265; B32B 2262/103; B32B 2250/40; B32B 2305/188; B32B 2305/38; B32B 2311/30; B32B 2419/06; E04D 5/10

(57) ABSTRACT

The present disclosure relates to moisture-impermeable membranes and discloses a waterproofing membrane for use with leak detection system. The membrane comprises, an intermediate layer fused between upper and lower waterproofing layer. The intermediate layer comprises conductive grid, formed by weaving conductive threads, that define a plurality of zones. Each zone comprises a cross sensor, formed by conductive threads. The conductive grid and the cross sensors are connected to a positive terminal of a power supply and negative terminal is connected to a deck. During leak detection, power supply to a selected cross sensor is disconnected, potential difference is measured between the cross sensor and the grid, and compared with a pre-defined threshold potential difference to identify leakage. The membrane eliminates complex wires and cables structure in comparison with conventional waterproofing and leak detection systems.

### TECHNICAL FIELD

The present disclosure generally relates to moisture-impermeable membranes used for roofing applications, and more particularly to a waterproofing membrane with leak detection system and method thereof.

### BACKGROUND

Generally, waterproofing is a process of making an object or a structure water-resistant so that the object or the structure remains unaffected by water under specific conditions. Waterproofing membranes, coatings and linings have long been used to protect structures or buildings, to contain water in ponds and decorative water features, to prevent leaching of contaminants from landfills, and for other purposes. For example, in construction, a building or a structure is waterproofed with the use of waterproofing membranes and coatings to provide an effective barrier against the seepage of rainwater and melted snow and ice through the roof into the interior of the building and hence to protect contents, and structural integrity. Such waterproofing membranes are typically in the form of a sheet of bituminous or thermoplastic material, such as APP, SBS, high density polyethylene (HDPE), polyvinyl chloride (PVC), thermoplastic polyolefin (TPO), EPDM, polyuria or polypropylene.

While such membranes have utility, leakage through the membrane is an on-going problem. Hence, it is necessary to test such membranes for leakages, both upon installation, and frequently thereafter. The efforts to locate such leakages resulted in rise of specialised consultants, and special equipment and methods. Exemplary conventional methods for leakage detection include manual methods, such as capacitance testing, infrared scanning, moisture probing, etc. Few advanced methods include, electrical circuitry and automated systems driven by computers with sensors built into or retrofitted to the non-conductive material of the roofing.

One exemplary conventional method is an electrical survey method which requires the membrane to be in contact with a conductive layer. An electrical potential is established across the membrane, and a conductive probe is then passed along the upper surface of the membrane. Leakage openings are either determined by the detection of sparks between the probe and the membrane in case of High Voltage testing methods OR by triangulating the breaches on zero centric ammeters/digital direction hand measurement tools in case of Low Voltage testing methods. Such services are offered by several companies like International Leak Detection (ILD) under the trademark of EFVM, Detec Systems under the trademark of ELD, Buckleys based in UK, SMT Research under the trademark of DigScan 360, etc. However, such method and implementation requires conductive layer to be glued or laminated or to be present to the bottom surface of the membrane. However, separation between the membrane and the conductive layer tends to occur over time which may result in faulty reading. Implementation is far difficult, time consuming and inaccurate in ‘concealed’ waterproofing membrane scenario and subject to possible corrosion, and stray faulty readings from building ground and uneven distribution of moisture in the overburden assembly.

Another exemplary conventional method provided by Progeo Gmbh of Germany and other associate vendors, comprises measuring humidity and temperature by installing relative humidity sensors in the roofing envelope. An array of such sensors provide give a representation of moisture conditions in a roofing envelope However, such sensors require a certain amount of free air around them in order to determine the ambient moisture content. Further, each sensor is only one point, measuring the relative humidity of a very small area around the sensor's location.

Other conventional systems provided by DETEC Systems of Bellingham, Wash. and SMT Research of Vancouver, BC require an electrically conductive surface/paint/mesh immediately below and in intimate contact with the membrane. Such systems include network of hydrophobic sensors tapes, wires and cables deployment of which is in a relatively complex manner on the top of the roof membrane. The membrane when wetted from water flowing through the roofing membrane, make a closed circuit that identifies which portion of the gird is wet and allows location of leakage through the membrane. The system requires significant amount of water to make its way to crossover point to trigger the alarm. Further it creates significant network of specialized cables and wires on the top of the membrane, which has to be done by a specialized agency, and are difficult to manage during and after the placement of overburden assembly. Further, the sensor cables are to be protected by stray electrical ground, which can come from overburden assembly while in contact with any conductive building element. Further, grid zones of the sensors on the top of the membrane has to be substantially large to ensure that leakage within one zone is not reflected in the adjacent zone, thereby reducing the accuracy of identification.

Hence, all the conventional systems have their own flaws, primary one being, the conventional systems are extremely intensive on physical network of wiring and cables. Further, adding multiple layers in roofing assembly requires specialized skillset to install, time, manpower, etc., and hence delaying the schedule and escalating the cost of installation and maintenance.

### SUMMARY OF THE DISCLOSURE

Thus there exists a need for a system and method which mitigates at least some of the disadvantages of the state of the art.

This summary is provided to introduce a selection of concepts in a simple manner that are further described in the detailed description of the disclosure. This summary is not intended to identify key or essential inventive concepts of the subject matter nor is it intended for determining the scope of the disclosure.

A waterproofing membrane, a method of detecting leakages in the waterproofing membrane, a system for detecting water leakages in the waterproofing membrane and a method of manufacturing the waterproofing membrane is disclosed. In some embodiments of the present disclosure, the waterproofing membrane comprises an upper waterproofing layer, a lower waterproofing layer, and an intermediate layer of flexible sensor scrim comprising a plurality of conductive threads forming a conductive grid that defines a plurality of zones, wherein each zone comprises a conductive cross sensor. In one implementation, the plurality of conductive threads are weaved between a plurality of non-conductive yarns to form the conductive grid that defines the plurality of zones and the plurality of conductive cross sensors is made of stainless steel yarns weaved at the centre of the each zone formed by the plurality of conductive threads.

Further, a method for detecting water leakage in one or more zones among the plurality of zones in the waterproofing membrane is disclosed. In some embodiments, the method comprises, connecting the conductive grid to a positive terminal of a power supply, independently connecting each of the cross sensor to the positive terminal of the power supply, connecting a negative terminal of the power supply to a conductive structural deck, selectively disconnecting the power supply to each of the cross sensor and measuring a potential difference between each of the cross sensor and the conductive grid in a pre-determined manner, and identifying one or more zones as leakage zones if the measured potential difference is greater than a pre-defined threshold potential difference.

Furthermore, a system for detecting water leakage in one or more zones among the plurality of zones in the waterproofing membrane is disclosed. In some embodiments, the system comprises, a monitoring box in electrical communication with the waterproofing membranes, wherein the monitoring box is configured for selectively connecting or disconnecting the power supply to the conductive grid and the each cross sensors using one or more relays, measuring a potential difference between each of the cross sensor and the conductive grid in a pre-determined manner, processing the measured potential difference values, identifying one or more zones as leakage zones if the measured potential difference is greater than a pre-defined threshold potential difference, and communicating a notification to one or more user devices or cloud or both in real-time or near real-time, wherein the notification comprises at least an identifier of the one or more leakage zones.

Furthermore, a method of manufacturing a waterproofing membrane is disclosed. In some embodiments, the method comprises, forming an intermediate layer of flexible sensor scrim and fusing the intermediate layer of flexible sensor scrim between an upper waterproofing layer and a lower waterproofing layer to form the waterproofing membrane. In one implementation, the intermediate layer of flexible sensor scrim is formed by weaving a plurality of conductive threads along with non-conductive yarns to form a conductive grid that defines a plurality of zones, and by weaving stainless steel yarns at the centre of the each of the each zone to form a plurality of conductive cross sensors.

In another embodiment of the present disclosure, the waterproofing membrane comprises an upper waterproofing layer and a lower waterproofing layer manufactured in two phases. Conductive stainless steel foil tapes are directly adhered to lower waterproofing layer to form a ‘Guard Circuit’ that defines a plurality of zones, wherein each zone comprises a conductive cross sensor adhered using the conductive stainless steel foil tape to form ‘Sensor Grid’ that collects data of surface resistivity of waterproofing membrane in real time. Each adhered sensors are independently connected to a monitoring box by a two-side laminated (insulated) connecting tracks which has conductive stainless steel foil tape in the core that transmits the data signals to the monitoring box as well as sequentially supply low voltage power to the sensors in a pre-defined sequence. Alternatively, connecting tracks may also be made using special solid core flat wire tape which connects each cross sensor independently to a monitoring box. The upper waterproofing layer is directly laminated on the lower waterproofing membrane with conductive sensors adhered to it.

Alternatively, in yet another embodiment of the present disclosure, the topside of lower waterproofing layer is directly digitally printed with super ‘Conductive INK’ made from either Graphene based compound or Multiwall Carbon Nanotubes to form a ‘Guard Circuit’ that defines a plurality of zones, wherein each zone comprises a centre conductive cross sensor printed using the same super ‘Conductive INK’ to form ‘Sensor Grid’ that collect data of surface resistivity of waterproofing membrane in real time. Each printed sensors are independently connected to a monitoring box by a two-side laminated (insulated) connecting tracks which has conductive INK printed in the core that transmits the data signals to the monitoring box as well as sequentially supply low voltage power to the sensors in a pre-defined sequence.

### BRIEF DESCRIPTION OF THE FIGURES

The disclosure will be described and explained with additional specificity and detail with the accompanying figures in which:

FIG. 1A illustrates lateral sectional view of a waterproofing membrane in accordance with an embodiment of the present disclosure;

FIG. 1B illustrates cross sectional view of the waterproofing membrane with a conductive structural layer/deck underneath in accordance with an embodiment of the present disclosure;

FIG. 2 illustrates an exemplary waterproofing 200 membrane comprising forty zones defined by plurality of conductive threads/ink printed bands/foil tapes (125-1 to 125-N) in accordance with an embodiment of the present disclosure;

FIGS. 3A, 3B, 3C and 3D illustrates graphical representation of potential difference readings between the each conductive cross sensors and the grid over an exemplary period of ten days in accordance with an embodiment of the present disclosure.

Further, persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION OF THE EXEMPLARY EMBODIMENTS

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

The embodiments herein disclose a waterproofing membrane with a system for detecting water leakage in the waterproofing membrane. The embodiments herein further disclose a method for detecting water leakage in the waterproofing membrane and a method of manufacturing the waterproofing membrane.

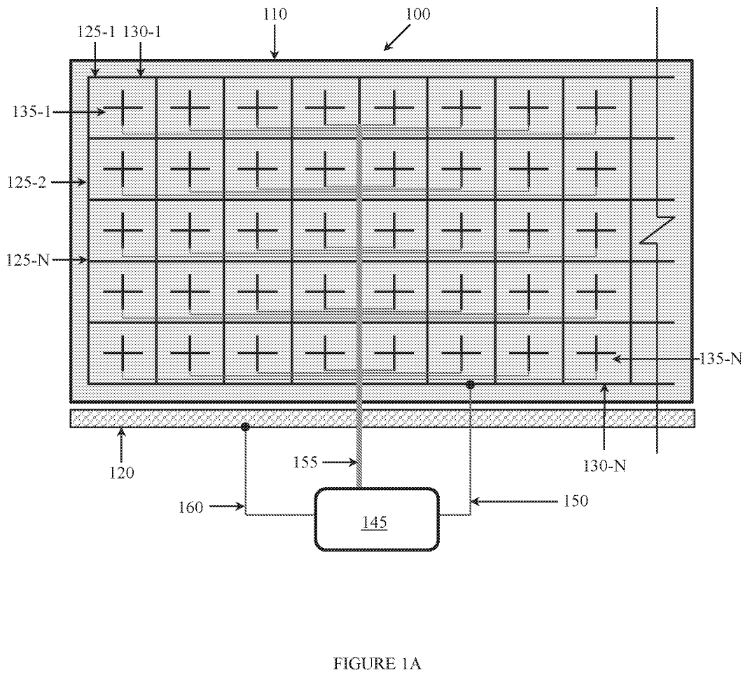

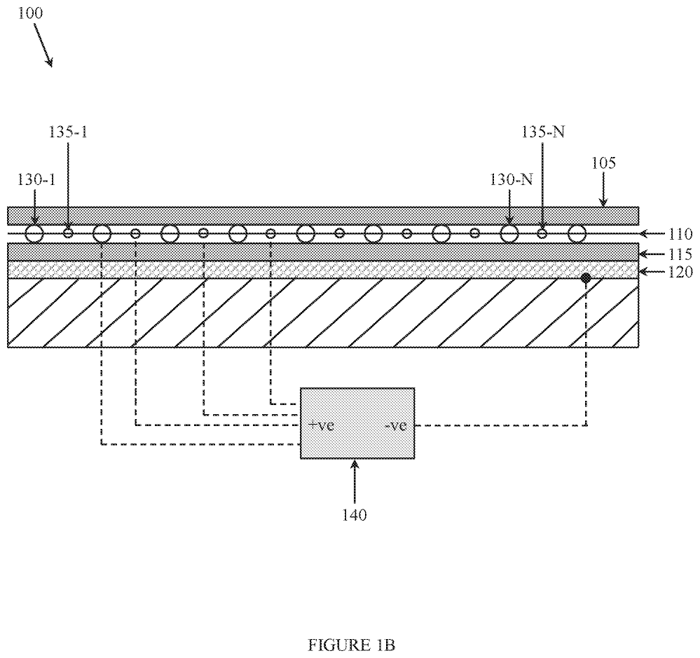

FIG. 1A illustrates lateral sectional view of a waterproofing membrane in accordance with an embodiment of the present disclosure. FIG. 1B illustrates cross sectional view of the waterproofing membrane with a conductive structural layer/deck underneath in accordance with an embodiment of the present disclosure. Referring to both the FIGS. 1A and 1B, the waterproofing membrane 100 comprises an upper waterproofing layer 105, an intermediate layer 110—a layer of flexible sensor scrim textile (sensor grid), and a lower waterproofing layer 115. In one implementation, the lower waterproofing layer 115 is laid directly on top of the conductive structural deck/layer 120 as shown in FIG. 1B, wherein the conductive structural layer 120 may be a concrete deck, paint, mesh, fabric, etc. Alternatively, the lower waterproofing layer 115 may be a part of the waterproofing membrane 100. Hence, the lower waterproofing layer may be an in-situ or a pre-formed layer. In one embodiment of the present disclosure, the upper waterproofing layer 105 and the lower waterproofing layers 115 are made of insulating water resistant material such as polymeric resin. Alternatively, the upper and the lower waterproofing layers 105 and 115 may be made of other known materials such as durable thermoplastic, such as HDPE, PVC, or polypropylene, etc.

In one embodiment of the present disclosure, the intermediate layer 110 (a layer of flexible sensor scrim or sensor grid) is made of non-conductive yarns and comprises a plurality of conductive threads forming a conductive grid that defines a plurality of zones, wherein the each zone comprises a conductive cross sensor. That is, in one implementation, stainless yarns are weaved between the plurality of non-conductive yarns to form the girds that defines the plurality of zones. Further, stainless steel yarns are weaved at the centre of the each zone to form the plurality of conductive cross sensors. Alternatively, the conductive threads forming the conductive grid and the conductive yarns forming the conductive cross sensor may be made of any conductive base material such as but not limited to stainless steel, copper, aluminum, brass, silver etc.

In another embodiment of the present disclosure, the waterproofing membrane comprises an upper waterproofing layer and a lower waterproofing layer manufactured in two phases. Conductive stainless steel foil tapes are directly adhered to lower waterproofing layer 115 to form a ‘Guard Circuit’ that defines a plurality of zones, wherein each zone comprises a conductive cross sensor adhered using the conductive stainless steel foil tape to form ‘Sensor Grid’ that collects data of surface resistivity of waterproofing membrane in real time. Each adhered sensors are independently connected to a monitoring box 145 by a two-side laminated (insulated) connecting tracks which has conductive stainless steel foil tape in the core that transmits the data signals to the monitoring box 145 as well as sequentially supply low voltage power to the sensors in a pre-defined sequence. Alternatively, connecting tracks may also be made using special solid core flat wire tape which connects each cross sensor independently to a monitoring box 145. The upper waterproofing layer 105 is directly laminated on the lower waterproofing membrane 115 with conductive sensors adhered to it.

Alternatively, in yet another embodiment of the present disclosure, the topside of lower waterproofing layer 115 is directly digitally printed with super “Conductive INK” made from either Graphene based compound or Multiwall Carbon Nanotubes to form the conductive grid (Guard Circuit) that defines a plurality of zones, wherein each zone comprises a centre conductive cross sensor printed using the same super ‘Conductive INK’ to form ‘Sensor Grid’ that collect data of surface resistivity of waterproofing membrane in real time. Each printed sensors are independently connected to a monitoring box 145 by a two-side laminated (insulated) connecting tracks which has conductive INK printed in the core that transmits the data signals to the monitoring box 145 as well as sequentially supply low voltage power to the sensors in a pre-defined sequence.

Referring to FIG. 1A, the intermediate layer 110 comprises a plurality of conductive threads or ink printed bands or foil tapes (125-1 to 125-N) forming a conductive grid (guard circuit) that defines a plurality of zones (130-1 to 130-N) and each zone comprises a conductive cross sensor (135-1 to 135-N) at the centre. As described, the conductive grid (guard circuit) defines the zones (130-1 to 130-N), and the stainless steel yarns weaved such a way as to divide the entire scanning area by zonal accuracy which may be (1 meter×1 meter) or lesser based on the desired accuracy. In the present example, the intermediate layer 110 (layer of sensor scrim textile) is divided into 40 zones (square shaped) by the plurality of conductive threads (125-1 to 125-N), each comprising a conductive cross sensor (135-1 to 135-N). As described, ink printed bands/foil tapes may be used to define the zones (130-1 to 130-N) and the layer of sensor scrim (layer of sensors).

Referring to FIG. 1B, in one embodiment of the present disclosure, the conductive grid is connected to a positive terminal of a power supply 140 and each of the cross sensors (135-1 to 135-N) are independently connected to the positive terminal of the power supply 140 as shown. Negative terminal of the power supply 140 is connected to the conductive structural deck 120 underneath the lower waterproofing layer 115. In other words, the negative terminal of the power supply 140 is connected to the building ground. In a preferred embodiment of the present disclosure, a 12V DC power supply is used which supplies 12V to the grid and 12V to each of conductive cross sensor (135-1 to 135-N).

In one embodiment of the present disclosure, leakage in the waterproofing membrane 100 is detected by measuring the potential difference between the grid and the conductive cross sensor. Hence, water leakage in one or more zones among the plurality of zones (130-1 to 130-N) in the waterproofing membrane 100 is detected by measuring a potential difference (a value) between each of the cross sensor and the grid in a pre-determined manner. That is, the potential difference in each zone, i.e., between each of the cross sensor and the grid is measured periodically and sequentially. If there is a leakage in a particular zone, there will be a voltage drop near the conductive cross sensor as compared to the constant voltage (for example, 12V) in the out grid, creating potential difference. Thus measured potential at each zone is compared with a pre-defined threshold potential difference (pre-defined value) to eliminate erroneous detection. If the measured potential difference in any of the zone is greater than the pre-defined threshold potential difference, then such zones are identified as leakage zones. In one implementation, the measured potential difference is processed, that is, amplified for graphical representation. Hence a system is provided for detecting water leakage in the waterproofing membrane 100, and the manner in which the system is implemented and operates in described in detail further below.

Referring to FIG. 1A, in one embodiment of the present disclosure, a system for detecting water leakage in one or more zones among the plurality of zones (130-1 to 130-N) in the waterproofing membrane 100 comprises a monitoring box 145 as shown. In one implementation, the monitoring box 145 is electrically connected to the waterproofing membrane 100 through a plurality of conductive tracks and/or cables (sensing probes) for measuring the voltage at the plurality of zones and the respective cross sensors.

As shown in FIG. 1A, the grid defining plurality of zones (130-1 to 130-N) is connected to the monitoring box 145 through a track 150 and each conductive cross sensor is independently connected to the monitoring box 145 through track 155. In one implementation, the track 155 is made of special polypropylene yarn with stainless steel conductive core thread functioning as an electrical wire but weaved or adhered on the flexible sensor scrim. In another implementation, the tack 155 is made a two-side laminated (insulated) connecting tracks which has printed conductive INK or adhered stainless steel foil tape in the core that transmits the data to the monitoring box 145. Alternatively, the connecting tracks 155 may also be made using special solid core flat wire tape which connects each cross sensor independently to a monitoring box 145. It has to be noted that the track 155 connects the each conductive cross sensor (135-1 to 135-N) independently to the monitoring box 145 and each cross sensor (hence the associated zone) is identified individually by the monitoring box 145. Further, the monitoring box 145 is connected to the conductive structural deck 120 (ground) through a track 160 in order to measure the potential difference.

In one embodiment of the present disclosure, the monitoring box 145 is further configured for selectively connecting or disconnecting the power supply to the grid and the each cross sensors of the waterproofing membrane 100 through known means such as relays. Hence, the power supply 140 (shown in FIG. 1B) may be a part of the monitoring box 145 or the power supply 140 may be connected to the waterproofing membrane 100 through the monitoring box 145, which enable selective connection or disconnection of the power supply to the grid and the each cross sensors of the waterproofing membrane 100 using one or more relays (not shown in Figure). Further, the monitoring box 145 comprises one or more microcontrollers for processing the measured potential difference and for identifying the one or more leakage zones, a memory unit for recoding the readings, a communication module for communicating the readings, etc. It is to be noted that the FIG. 1A illustrates sensor circuitry of the waterproofing membrane along with the monitoring box 145, and FIG. 1B illustrates electrical connection, independently. The manner in which the one or more leakage zones are identified is described in detail further below.

Initially, the conductive grid that defines a plurality of zones (130-1 to 130-N) is connected to the positive terminal of the power supply 140 and each of the cross sensor (135-1 to 135-N) associated with the plurality of zones (130-1 to 130-N) are independently connected to the positive terminal of the power supply 140. Further, the negative end of the power supply 140 is connected to the structural deck, on which the waterproofing membrane is deployed. As described, the monitoring box 145 is configured for controlling the power supply to the 110 layer of sensor scrim textile (layer of sensors) and further configured for detecting one or more leakage zones in the waterproofing membrane 100. In one embodiment of the present disclosure, the monitoring box 145 selects one zone at a given time, and disconnects the power supply to that particular zone (i.e., to the cross sensor of the selected zone) keeping positive supply to all other cross sensors and the conductive grid. Then the monitoring box 145 measures the potential difference in the selected zone, i.e., between the conductive grid and the cross sensor of the selected zone. The measured potential difference is compared with the pre-defined threshold potential difference to identify the leakage, if any. For example, if the pleasured potential difference is 0.8V and the pre-defined threshold potential difference is 0.5V, then the monitoring box 145 identifies that zone as a leakage zone and notifies the same to the user. Similarly, the monitoring box 145 selects further zones, one at a time, disconnects the power supply to the cross sensor, measures the potential difference, and compares the measured potential difference to detect leakages in one or more zones in the waterproofing membrane, if any. Hence, the monitoring box 145 selectively disconnects the power supply to each of the cross sensor and measures the potential difference between each of the cross sensor and the conductive grid in a pre-determined manner, that is, one at a time, and identifies the one or more zones as leakage zones if the measured potential difference is greater than a pre-defined threshold potential difference. Further, the monitoring box 145 may be configured to identify the one or more leakage zones periodically, for example, for every 30 minutes, 1 hour, one day or continuously after every cycle. The method of disconnecting the power supply to the selected/currently monitoring zone, that is the cross sensor associated with the selected zone, keeping all other cross sensor at positive supply nullifies the reciprocal effects of leakages in multiple zones on the one being monitored at the given time.

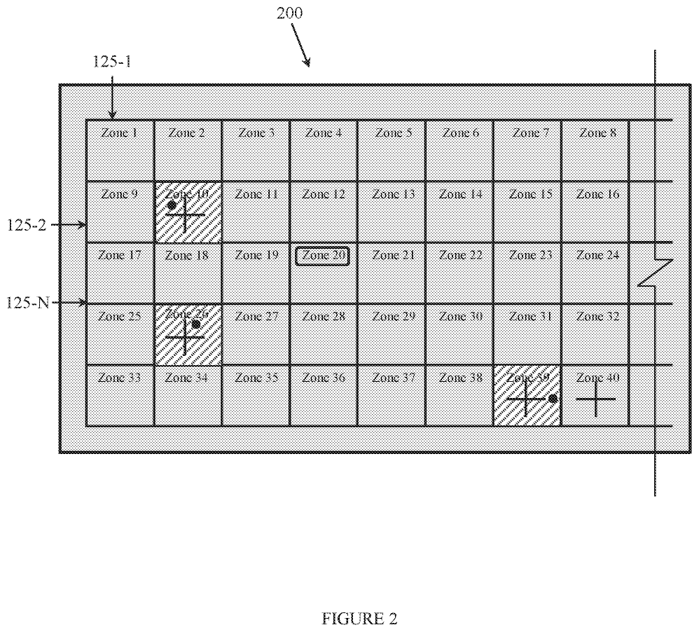

FIG. 2 illustrates an exemplary waterproofing 200 membrane comprising forty zones defined by plurality of conductive threads/ink printed bands/foil tapes (125-1 to 125-N) in accordance with an embodiment of the present disclosure. As described, number an size of the zones may be altered based on the desired leakage detection accuracy, roof area, number of connection terminals, etc. Further, each zone comprises a conductive cross sensor and hence the exemplary waterproofing membrane 200 comprises forty conductive cross sensors (not shown).

The manner in which the leakage zones are detected is described considering two scenarios. In the first scenario, “Zone 10”, “Zone 20” and “Zone 26” are considered in which the “Zone 10” and “Zone 26” has a leaking point (indicated by black dot) and “Zone 20” is intact without any breaches in the lower and the upper waterproofing layers. In the second scenario, “Zone 39” and “Zone 40” are considered in which the “Zone 39” has a leaking point (indicated by black dot) near to the thread/ink printed bands/foil tapes defining the zones “39 and 40”.

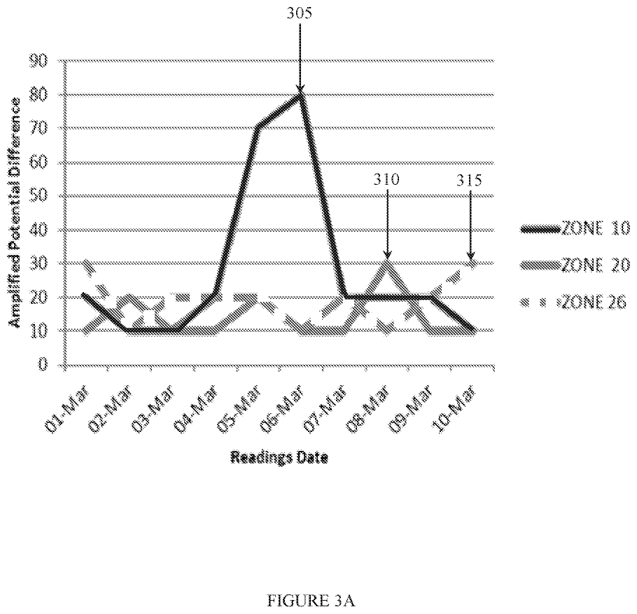

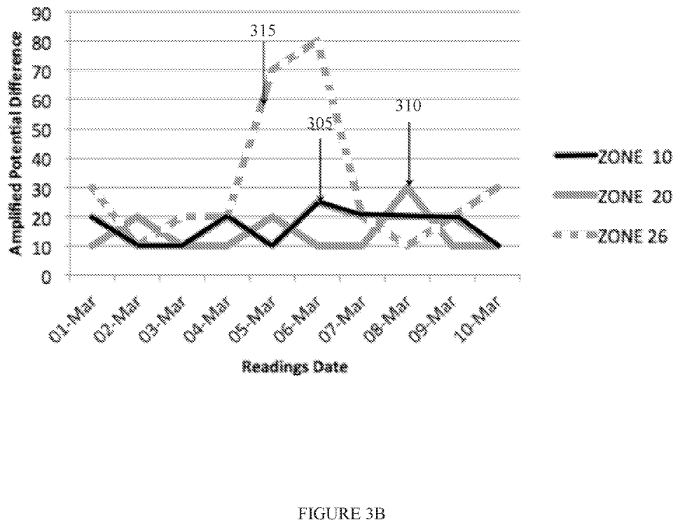

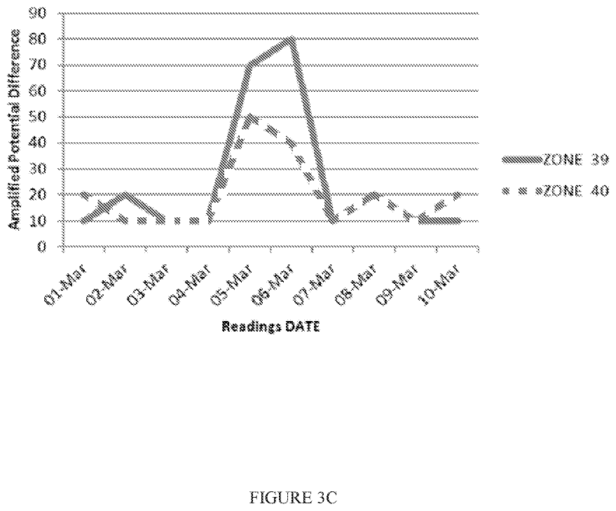

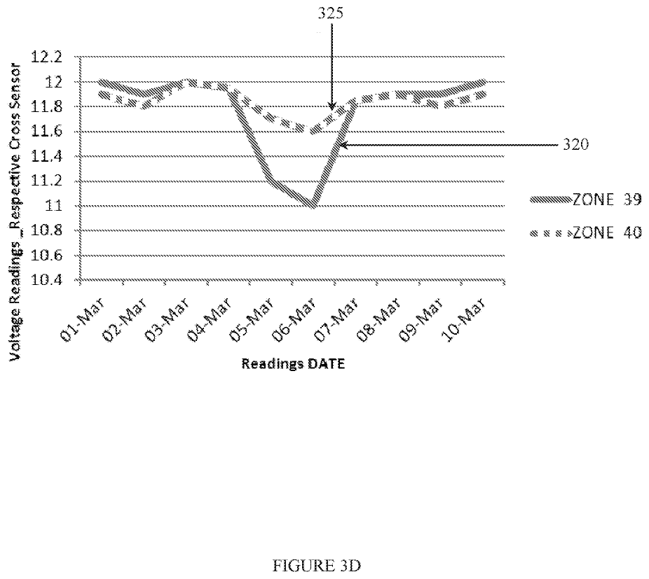

In a preferred embodiment of the present disclosure, a 12V DC power supply is used which supplies 12V to the conductive grid and 12V to each of conductive cross sensor (135-1 to 135-N) except for the Zone sequentially being monitored at a given time. The potential difference between the each conductive cross senor and the grid is measured periodically and compared with the pre-defined threshold potential difference to detect any breach/leakage in the waterproofing membrane. FIGS. 3A, 3B, 3C and 3D illustrates graphical representation of potential difference readings between the each conductive cross sensors and the grid over an exemplary period of ten days in accordance with an embodiment of the present disclosure. The figures illustrate amplified potential difference and the pre-defined threshold potential difference is considered as 50V, for example.

As depicted in FIG. 3A, on exemplary date of March 6^{th}, when “Zone 10” is being monitored, the power supply to the cross sensor of “Zone 10” is disconnected keeping all other cross sensors at 12V to nullify the reciprocal effects of leakages in multiple zones on the “Zone 10”. In this example, the average of potential difference readings between outer grid (Zone 10) and the respective cross sensor is above the pre-defined threshold potential difference limit in ZONE 10, as indicated by the black line 305. Hence, the monitoring box 145 triggers an alarm/notification in multiple forms to indicate “Zone 10” as a leaking zone. On the other hand, potential difference at “Zone 20” and “Zone 26” are within the pre-defined threshold potential difference limit (indicated by grey line 310 and dotted grey line 315) indicating either of two scenarios like normal situation of the waterproofing membrane integrity or leakage being nullified temporarily to avoid false readings. When the breach in “Zone 10” is fixed on exemplary date of March 7^{th}, all potential difference resort back to within the threshold limits indicating normal scenario of waterproofing membrane integrity.

Similarly, referring to FIG. 3B, on exemplary date of March 6^{th}, when “Zone 26” is being monitored, the power supply to the cross sensor of “Zone 26” is disconnected keeping all other cross sensors at 12V to nullify the reciprocal effects of leakages in multiple zones on the “Zone 26”. Since the average of potential difference readings between outer grid (Zone 26) and the respective cross sensor is above the pre-defined threshold potential difference, as indicated by the dotted line 315, the monitoring box 145 triggers an alarm indicating breach in “Zone 26”.

Referring to the second scenario in which the breach is near to the thread/ink printed bands/foil tapes defining the adjacent zones “39 and 40”, the potential difference readings between the conductive grid and the respective conductive cross sensors on “Zone 39” and “Zone 40” may be above the pre-defined threshold potential difference limit (for example 50V) as depicted in FIG. 3C, on an exemplary date March 6^{th}, creating false alarm. Hence, in one embodiment of the present disclosure, the monitoring box 145 is configured to turn “OFF” the voltage in the conductive grid to analyze and identify leaking zone with the accuracy. In such a scenario, the monitoring box 145 turns “OFF” the supply to the conductive grid and the voltage drop on both the conductive cross sensors (representing Zone 39 and Zone 40) are measured and compared to detect the leakage zone. As depicted in FIG. 3D, since the breach is in “Zone 39”, the voltage drop on the cross sensor of “Zone 39” (indicated by the line 320) is higher as compared to “Zone 40” (indicated by dotted line 325). Hence, the monitoring box 145 triggers an alarm indicating leak in “Zone 39”. It has to be noted that the monitoring box 145 may configured to trigger an alarm, communicate a notification to one or more user devices, such as smartphones, record the readings in a cloud server, etc. Further, the monitoring box 145 may include or may have means to connect to an input/output device for displaying the readings in any of the known format, such as graphical representations.

It has to be noted that by changing the type of the conductive yarn/threads/ink printed bands/foil tapes (stainless steel/copper/silver, etc.) in order to get different conductivity readings, the spacing and layout of the conductive cross sensors may be altered depending upon the requirement of the end product.

In one embodiment, by changing the weaving pattern of the “flexible sensor scrim” (layer of sensors) or by changing the printing layout of conductive ink used to create sensors OR by changing adhering pattern of the center cross sensors, the system may be configured to monitor more parameters including but not limited to temperature, condensation and snow load. For example, temperature can be measured directly above the waterproofing membrane and underneath the roof assembly by implementing the same sensors on the waterproofing membrane. Such measurement assists in taking appropriate action, for example irrigation. In another example, in a built-up roofing assembly, by placing a sensor in outside environment to monitor atmospheric condensation levels and using sensor on waterproofing membrane to monitor the dew point and trigger appropriate corrective action.

It is to be noted that the layer placement of the “flexible sensor scrim” (layer of sensors) within the waterproofing membrane may be altered depending upon the type of waterproofing method and associated application methods. Irrespective of the sequence in which the flexible sensor scrim is sandwiched or fused or adhered or printed within the waterproofing membrane, it does not primarily alters the intent to monitor and trigger alarms in case of moisture leakage and other parameters in observation Further, the dimensions of the flexible sensor scrim may be altered depending upon the sought physical dimension of waterproofing membrane.

Further, “the flexible sensor scrim” may be used independently on any kind of third party's waterproofing membrane (in-situ or pre-formed) for detecting membrane leakages in real-time. Printing, adhering or fusing the “flexible sensor scrim” with membrane is an extended feature; however using the same independently does not primarily alter the intent to monitor and trigger alarms in case of moisture leakage in the membrane and other parameters in observation.

Hence, the waterproofing membrane with leakage detection system disclosed in the present disclosure provides exact breach location in case of any breach in the waterproofing membrane.

Further, conductive threads and the conductive cross sensors are weaved between the non-conductive yarns to form a flexible sensor scrim textile, reducing complex wires and cables structure as compared with the conventional leak detection systems.

Furthermore, using super conductive ink printed bands/foil tapes to form a flexible sensor scrim textile, reduces complex wires and cables structure as compared with the conventional leak detection systems.

Furthermore, the waterproofing membrane may be economically manufactured with or without the lower waterproofing layer, provides good structural integrity and can be easily installed, without extensive additional training.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1.-14. (canceled)

15. A waterproofing membrane for waterproofing a roof, the waterproofing membrane comprising:
an upper waterproofing layer and a lower waterproofing layer for waterproofing the roof;
an intermediate layer of flexible sensor scrim comprising a plurality of conductive threads forming a conductive grid for defining a plurality of zones, wherein the plurality of conductive threads are for receiving a supply voltage; and
wherein each zone comprises a conductive cross sensor for use for sensing a potential difference, for detecting leakage in the waterproofing membrane.

16. The waterproofing membrane as claimed in claim 15, wherein the lower waterproofing layer is one of an in-situ or a pre-formed layer.

17. The waterproofing membrane as claimed in claim 15, wherein the upper waterproofing layer and the lower waterproofing layer are made of insulating water-resistant material.

18. The waterproofing membrane as claimed in claim 15, wherein the plurality of conductive threads are weaved between a plurality of non-conductive yarns to form the conductive grid for defining the plurality of zones.

19. The waterproofing membrane as claimed in claim 15, wherein each of the conductive cross sensor is made of stainless steel yarns weaved at the centre of the each zone formed by the plurality of conductive threads.

20. A method for detecting water leakage in one or more zones among a plurality of zones in the waterproofing membrane as claimed in claim 15, the method comprising:
connecting a conductive grid to a positive terminal of a power supply; connecting, independently, each of cross sensor associated with the plurality of zones to the positive terminal of the power supply;
connecting a negative terminal of the power supply to a conductive structural deck;
selectively disconnecting the power supply to each of the cross sensor and measuring a potential difference between each of the cross sensor and the conductive grid in a pre-determined manner; and
identifying one or more zones as leakage zones if the measured potential difference is greater than a pre-defined threshold potential difference.

21. A method of detecting a selected zone among a plurality of zones in the waterproofing membrane claimed in claim 15 as having water leakage, the method comprising:
connecting the conductive grid to a positive terminal of a power supply; connecting, each of the cross sensors associated with the plurality of zones other than the selected zone, to the positive terminal of the power supply;
connecting a negative terminal of the power supply to a conductive structural deck; measuring a value of a potential difference between the cross sensor associated with the selected zone and the conductive grid; and
detecting that the selected zone as having water leakage if the value is greater than a pre-defined value.

22. The method as claimed in claim 20, wherein each zone among the plurality of zones are selected sequentially in a pre-defined manner for detecting leakage in the one or more zones among the plurality of zones in the waterproofing membrane.

23. A system for implementing the method as claimed in claim 20, the system comprising:
a monitoring box in electrical communication with the waterproofing membranes, wherein the monitoring box is configured for:
selectively connecting or disconnecting the power supply to the conductive grid and the each cross sensors;
measuring a potential difference between each of the cross sensor and the conductive grid in a pre-determined manner;
processing the measured potential difference values; and
identifying one or more zones as leakage zones if the measured potential difference is greater than a pre-defined threshold potential difference.

24. A method of manufacturing the waterproofing membrane as claimed in claim 15, the method comprising:
forming the intermediate layer of flexible sensor scrim, characterized by:
weaving a plurality of conductive threads along with non conductive yarns to form the conductive grid for defining a plurality of zones;
weaving stainless steel yarns at the centre of each zone to form the plurality of conductive cross sensors; and
fusing the intermediate layer of flexible sensor scrim between the upper waterproofing layer and the lower waterproofing layer to form the waterproofing membrane.
